(19) United States
(12) Patent Application Publication
(10) Pub. No.: US 2011/0234918 A1
(43) Pub. Date: Sep. 29, 2011

(54) PROJECTOR AND PROJECTING IMAGE ADJUSTING METHOD THEREOF

(75) Inventors: MING-CHIH HSIEH, Tu-Cheng (TW); YAU-LEUNG CHAN, Santa Clara, CA (US)

(73) Assignee: HON HAI PRECISION INDUSTRY CO., LTD., Tu-Cheng (TW)

(21) Appl. No.: 12/764,068

(22) Filed: Apr. 20, 2010

(30) Foreign Application Priority Data
Mar. 23, 2010 (TW) 99108594

(51) Int. Cl. H04N 9/31

(52) U.S. Cl. 348/744; 348/E09.025

(57) ABSTRACT

A projector includes an image signal interface, a micro control unit (MCU), an image output lens, a graphic processing unit (GPU), an image input lens, and an image sensor. The MCU receives image signals through the image signal interface and sets the image signals to a default image parameter configuration. The GPU processes the set image signals to project the set image signals in a configuration of an image on a certain place through the image output lens. The image input lens captures the projected image on an appropriate place. The MCU receives actual image data corresponding to the captured projected image through the image sensor. The MCU compares the actual image data with predetermined image data, and adjusts image parameters of the image signals until a difference between the actual image data and the predetermined data is equal to or less than a predetermined value.

### BACKGROUND

1. Technical Field

The present disclosure relates to projectors, and particularly, to a projector and a method which can automatically adjust a projecting image of the projector.

2. Description of Related Art

Nowadays, projectors are widely used in many places, such as classrooms, or meeting rooms. When in use, a projector is usually put on a table first, and then turned on, after that a projected image will be shown on a display screen. Many times, the projected image may not be clear, so we need to adjust the image parameters by pressing corresponding adjusting buttons on the projector, which can be inconvenient and time-consuming.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an embodiment of a projector.

FIG. 2 is a flowchart of an embodiment of a projecting image adjusting method.

### DETAILED DESCRIPTION

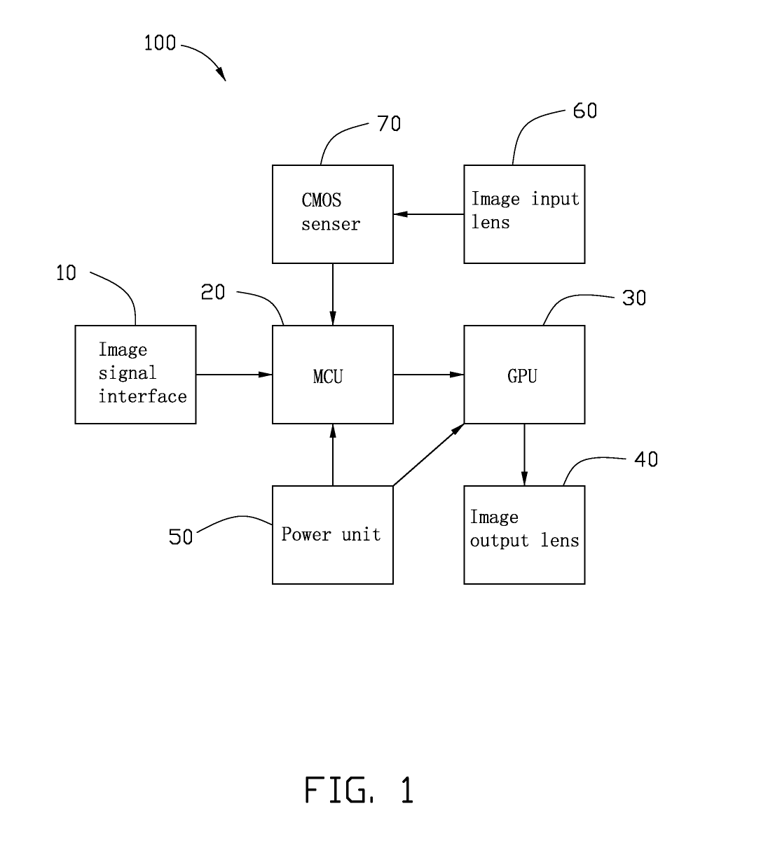

Referring to FIG. 1, an embodiment of a projector 100 includes an image signal interface 10, a micro control unit (MCU) 20, a graphic processing unit (GPU) 30, an image output lens 40, a power unit 50, an image input lens 60, and an image sensor, such as a complementary metal oxide semiconductor (CMOS) sensor 70.

The power unit 50 supplies power to the MCU 20 and the GPU 30. The image signal interface 10 is used to receive image signals from an external device, such as a computer (not shown). The MCU 20 receives the image signals and sets the image signals to a default image parameter configuration, such as setting a contrast ratio parameter, a pixel parameter, and a luminance parameter to the image signals. After setting the image parameters, the MCU 20 transfers the set image signals to the GPU 30. The GPU 30 receives the set image signals and processes these set image signals, to project the set image signals in a configuration of an image on an appropriate place, such as a display screen (not shown), through the image output lens 40. Many times, the projected image on the display screen is not clear.

To resolve the above problem, the image input lens 60 captures the projected image on the display screen in real time. The MCU 20 receives an actual image data corresponding to the captured projected image through the CMOS sensor 70. The MCU 20 stores predetermined image data therein, and the predetermined image data accordant with users' requirements. The MCU 20 compares the actual image data with the predetermined image data. If the difference between the actual image data and the predetermined image data is greater than a predetermined value, for example, the contrast ratio parameter of the actual image data is greater than 2%, the MCU 20 will adjust the image parameters of the image signals, until the actual image data are equal to or less than the predetermined value. After that, the final projected image on the display screen is clear and accordant with users' requirements. Because the projector 100 can automatically adjust image parameters by the MCU 20, the projector 100 can be used very conveniently and easily.

Adjusting programs of the MCU 20 for adjusting the image parameters of the image signals may be designed according to requirements, such as adding or decreasing 1% to the corresponding image parameters each adjustment. The image input lens 60 can be rotated to any angle in order to directly face the display screen.

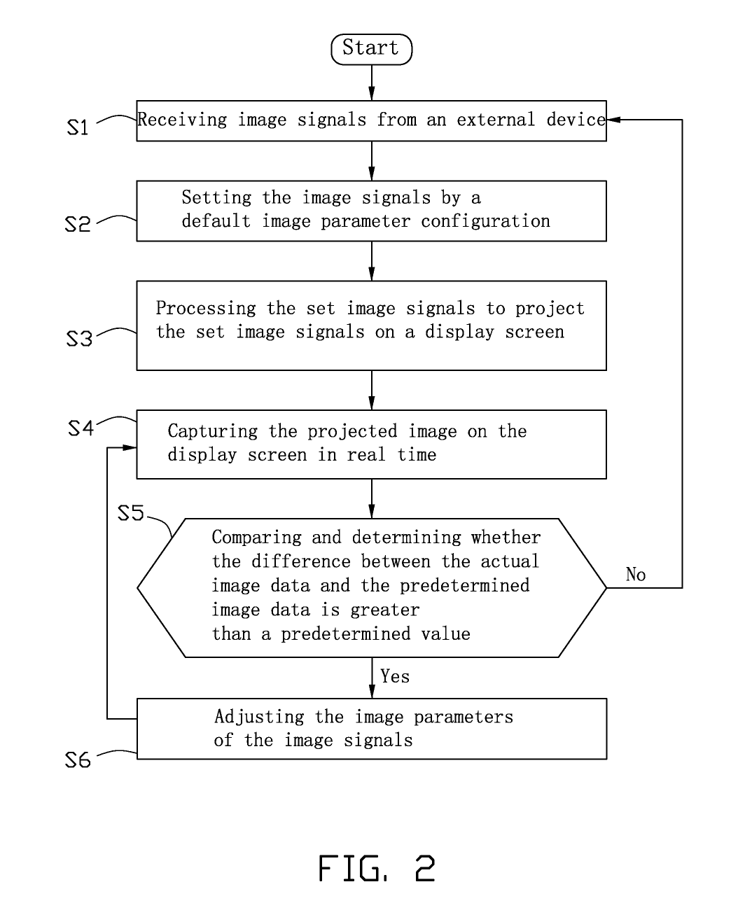

Referring to FIG. 2, an embodiment of a projecting image adjusting method includes the following steps.

Step S1, The image signal interface 10 receives the image signals from an external device, such as a computer (not shown).

Step S2, the MCU 20 receives the image signals and sets the image signals to a default image parameter configuration.

Step S3, the GPU 30 receives the set image signals and processes these set image signals, to project the set image signals in a configuration of an image on a display screen through the image output lens 40.

Step S4, the image input lens 60 captures the projected image on the display screen in real time.

Step S5, the MCU 20 receives actual image data corresponding to the captured projected image through the CMOS sensor 70, and compares the actual image data with predetermined image data stored in the MCU 20. If the difference between the actual image data and the predetermined image data is greater than a predetermined value, the process goes to step S6. If the difference between the actual image data and the predetermined image data is equal to or less than the predetermined value, the process goes back to step S1.

Step S6, the MCU 20 adjusts the image parameters of the image signals, and then the process returns to step S4.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A projector comprising:
an image signal interface;
a micro control unit (MCU) to receive image signals through the image signal interface and set the image signals to a default image parameter configuration;
an image output lens;
a graphic processing unit to receive the set image signals and process the set image signals, to project the set image signals in a configuration of an image through the image output lens;
an image input lens to capture the projected image; and
an image sensor;
wherein the MCU receives an actual image data corresponding to the captured projected image through the image sensor, the MCU compares the actual image data with predetermined image data stored in the MCU, and adjusts the image parameters of the image signals until a difference between the actual image data and the predetermined data is equal to or less than a predetermined value.

2. The projector of claim 1, wherein the image sensor is a complementary metal oxide semiconductor sensor.

3. A projecting image adjusting method comprising:
receiving image signals;
setting the image signals to a default image parameter configuration;
processing the set image signals and projecting the set image signals in a configuration of an image;
capturing the projected image;
comparing actual image data corresponding to the captured projected image with predetermined image data, wherein the process goes to the step of receiving image signals, in response to a difference between the actual image data and the predetermined image data being equal to or less than a predetermined value; and
adjusting image parameters of the image signals, and then returning to the step of capturing the projected image, in response to a difference between the actual image data and the predetermined data being greater than the predetermined value.
